(19) United States
(12) Patent Application Publication
(10) Pub. No.: US 2023/0206219 A1
(43) Pub. Date: Jun. 29, 2023

(54) Identification token, systems and methods for identification and identity verification.

(71) Applicant: Duy Khuong, Paris (FR)

(72) Inventor: Duy Khuong, Paris (FR)

(21) Appl. No.: 18/091,118

(22) Filed: Dec. 29, 2022

Related U.S. Application Data
(60) Provisional application No. 63/346,893, filed on May 29, 2022.
(60) Provisional application No. 63/324,869, filed on Mar. 29, 2022.
(60) Provisional application No. 63/326,842, filed on Apr. 2, 2022.
(60) Provisional application No. 63/294,504, filed on Dec. 29, 2021.

(51) Int. Cl. G06Q 20/36; G06Q 20/38

(52) U.S. Cl. CPC G06Q 20/3674; G06Q 20/3827; G06Q 20/3825

(57) ABSTRACT

An exemplary embodiment comprises at least one identification (ID) token (16) held in a crypto wallet (14) owned by an individual (12), and one registry record (24) managed by a registrar smart contract (18). The ID token contains an identification hash which uniquely represents the individual's identity, and an address which points to a registration authority. The authority is the one who has confirmed the identity of the individual and created the registry record (24). The registry record (24) contains a unique value which is cryptographically computed from the wallet address (30) and the ID token address (31). By asking the registrar (18) for the existence of the registry record (24), applications and service providers (10) can reliably verify the identity of the individual (12) without the individual (12) submitting ID documents, therefore reducing the risk of exposing sensitive data to untrusted parties. Other embodiments are described and shown.

### CROSS-REFERENCE TO RELATED APPLICATIONS

This application claims the benefit of provisional patent applications Ser. No. 63/294,504, filed 2021 Dec. 29, Ser. No. 63/324,869, filed 2022 Mar. 29, Ser. No. 63/326,842, filed 2022 Apr. 2, and Ser. No. 63/346,893, filed 2022 May 29 by the present inventor, which are incorporated by reference in their entirety.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Many online activities, especially financial ones, require that the real-life identity of a user is verified before they can be conducted. Currently, almost all of the methods for identity verification require that the user submits scanned identification papers (e.g. passport, national ID card, driver's license, etc.) to a third party. When the person uses a new application or service, they usually have to go through the whole process again. On one hand, this process consumes time and effort; on the other hand, sending confidential documents to a different party each time increases the risk of exposing private data to untrusted parties. Not all companies are qualified to handle such data, and different companies also have different policies and practices for handling it. The user currently has no other option but to trust what the application or service provider offers. There is no universal way that users and service providers on the internet can be relied upon to quickly and reliably verify a user's real-life identity for online transactions.

### BRIEF DESCRIPTION OF DRAWINGS

These and other features, aspects, and advantages of the present disclosure will become better understood with regard to the following descriptions, claims, and accompanying drawings. It is to be noted, however, that the drawings illustrate only several embodiments of the described technology and are therefore not to be considered limiting in scope as it can admit to other equally effective embodiments.

FIG. 1A illustrates an overview of an embodiment for identification and identity verification;

FIG. 1B is a flow diagram illustrating the steps in a typical usage of an Identification (ID) token;

FIG. 1C illustrates an imaginary talk between main components;

FIG. 2A illustrates the components involved in a process of creating an ID token;

FIG. 2B visualizes and simplifies the way information is stored in an ID token;

FIG. 2C is a sequence diagram illustrating the process of creating an ID token;

FIG. 2D is a flow diagram illustrating a sub-process of forming an ID token;

FIG. 2E illustrates an alternative version of FIG. 2B where an ID photo is not used;

FIG. 2F illustrates an alternative version of FIG. 2C where an ID photo is not used;

FIG. 2G illustrates an alternative version of FIG. 2D where an ID photo is not used;

FIGS. 3A to 3D illustrate various aspects of an ID token registration process;

FIG. 3A illustrates an overview of the process;

FIG. 3B is a sequence diagram illustrating the same process;

FIG. 3C is a flow diagram illustrating a sub-process of forming a registry record;

FIG. 3D is a sequence diagram illustrating a process of migrating an ID token to a new crypto wallet;

FIGS. 4A to 4H are related to the processes of identification and identity verification;

FIGS. 4A and 4B illustrate overall views of the processes;

FIG. 4A illustrates a use-case where a crypto wallet is responsible for getting the identification and verification statuses;

FIG. 4B illustrates another use-case where an application is responsible for getting the identification and verification statuses;

FIG. 4C is a sequence diagram illustrating the Identification process;

FIG. 4D is a sequence diagram illustrating the Identity verification process;

FIGS. 4E and 4H are flow diagrams illustrating a sub-process of confirming user-provided information with the information stored in an ID token;

FIG. 4E is for an ID token with an ID photo;

FIG. 4H is for an ID token without an ID photo;

FIG. 4F visualizes the process of identity verification;

FIGS. 4G and 4I both visualize the process of identification;

FIG. 4G is for an ID token with an ID photo;

FIG. 4I is for an ID token without an ID photo;

FIG. 5 illustrates class diagrams designed for an ID token and a registry record;

FIG. 6 is a diagram showing an overall view of how a registry record is stored on a blockchain; and

FIG. 7 is a table defining the rules to calculate an identification hash.

### DRAWINGS—REFERENCE NUMERALS

A list of reference numerals used in the drawings:
10: internet/blockchain application/service
11: identification information (IDI)
12: user, individual
13: original identification (ID) photo
14: crypto wallet of user
14N: new crypto wallet of user
15: encrypted ID photo
16: ID token
17: metadata file
18: registrar smart contract
19: evidence
20: creator smart contract
21: crypto wallet of registration authority
22: blockchain
23: registration authority
24: registry record
25: identification hash, ID hash
251: information-only hash, hash1
252: checksum
26: ID type
27: URI of a metadata file, token URI
28: registrar address
29: isIdentified( ) interface
30: user's wallet address
31: user's ID token address
32: registry hash
33: isVerified( ) interface
52: computed hash

### DETAILED DESCRIPTION OF THE INVENTION

Various embodiments of the disclosed methods and arrangements are discussed in detail below. While specific implementations are discussed, it should be understood that this is done for illustration purposes only. A person skilled in the relevant art will recognize that other components, configurations, and steps may be used without parting from the spirit and scope of the disclosure.

### System Overview

The example embodiments are directed to systems and methods for identification and identity verification, utilizing identification (ID) tokens. An ID token is a new kind of digital identity based on blockchain technology. It is used for verifying real-life identity without the need to provide evidence (i.e. scanned photos of physical ID cards, etc.,) when a user needs to verify their identity on the internet.

ID token does this by creating a non-fungible token (NFT) that has the person's identification information and associating it with their crypto wallet. When the person needs to prove their identity, they just needs to log in (or sign in) to their wallet. The association is certified by a trusted party known as a registrar (or a registration authority). However, in order to be certified by the registrar, the person needs to provide the evidence (e.g. ID scans, government-issued documents, etc.) in the registration process, to make sure that the individual currently accessing the wallet has the same identity as that indicated by the ID token. Once the registrar has confirmed the evidence, a registry record is created and stored permanently on the blockchain, which can be used for identity verification later.

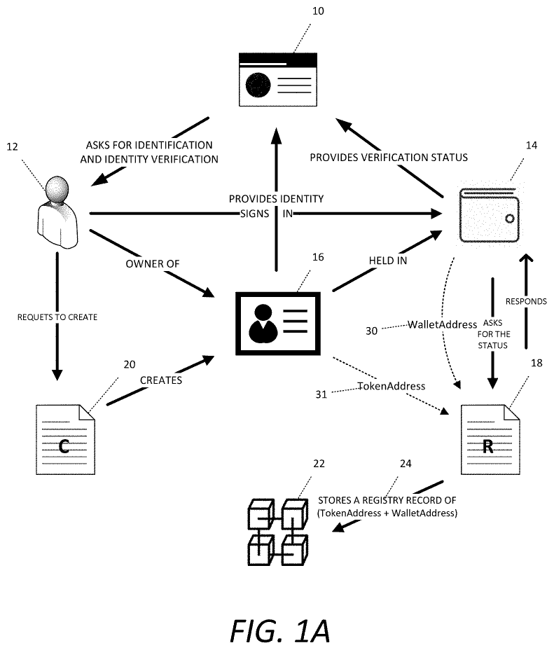

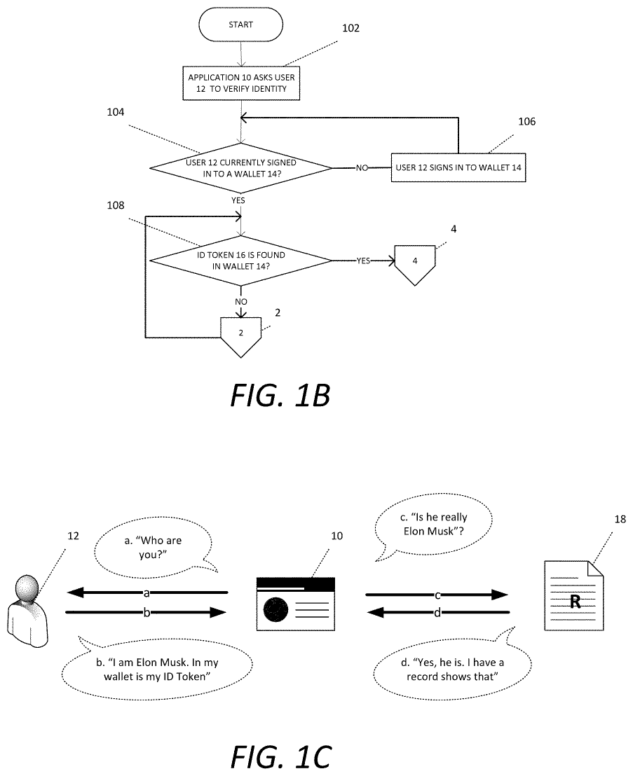

FIG. 1A describes an overall view of an exemplary embodiment when an ID token is created, registered and used. The system comprises: an ID token 16, a creator smart contract (creator) 20, a registrar smart contract (registrar) 18 and a registry record 24, which are parts of the embodiment; and an application 10, user 12, wallet 14 and blockchain 22, which are not parts of, but are used in connections with, the embodiment. The relationships between these components are described as follows.

The application 10 asks the user 12 for their identification. The user 12 has signed into their crypto wallet 14. Inside their wallet 14 is the ID token 16. This ID token 16 was produced by the creator 20. The ID token 16 and wallet 14 have been registered together by the registrar 18. This registration was recorded on blockchain 22 as the registry record 24.

The ID token 16, the registry record 24, and their corresponding smart contracts: creator 20 and registrar 18, are main components that form the foundation of the embodiment. We will discuss them in detail in the following sub-sections.

### Identification Token

Identification token is a kind of non-fungible token (NFT) on a blockchain that includes some new properties to represent an identity. For example, that identity can be a real-life identity (with details matching those on a passport, national ID card, etc.,) or a virtual identity (representing a metaverse ID, virtual land residency card, etc.).

The type of the ID token is defined by an identification type (ID type) while the information the token represents is stored in a hashed value named identification hash (ID hash). In order to create an ID token, one should provide all fields of identification information (IDI) needed, which may vary depending on the ID type. The ID hash will be calculated based on this information, and its value will be saved permanently in the token. This value may not be modified once the token has been created. The details of ID type and the calculation of the ID hash are discussed in Specification [A] sub-section of Identification Token Creation Process section below.

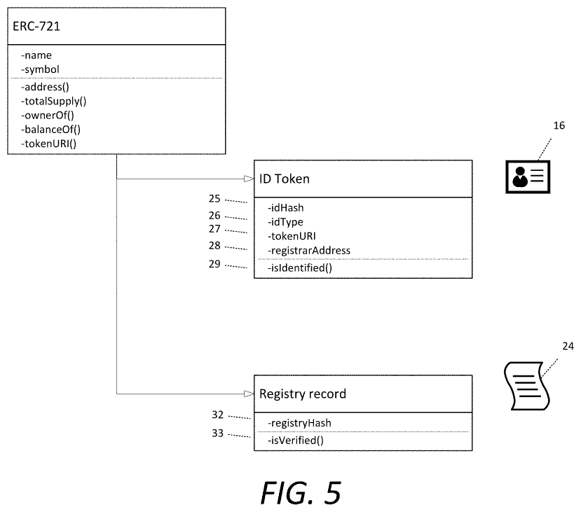

FIG. 5 shows a class diagram for an ID token (with a class diagram of a registry record, which will be discussed later). It is an extended class of the standard Ethereum Request for Comments 721 (ERC-721), deployed on the Ethereum blockchain.

Although the exemplary embodiment described herein employs ERC-721 and the Ethereum blockchain, it should be appreciated by those skilled in the art that other standards like ERC-1155 or similar, on another private or public blockchain might also be used as a base for implementing the ID token.

In the displayed embodiment (FIG. 5), while the ID token 16 keeps the original properties such as name and symbol of the ERC-721 standard, it has some new properties which are: idHash 25, idType 26, registrarAddress 28 and an interface isIdentified( ) 29.

The type of the ID token 16 is defined by its idType (ID type) 26 while the information it represents is stored in idHash (ID hash) 25. When the ID token 16 is created, apart from these two values, a registrarAddress (registrar address) 28 also needs to be specified. The registrar address 28 is the address of a crypto wallet, which belongs to a registration authority. This registration authority is the agent that confirms and validates all of evidence submitted by the user in the ID token registration process. More on registrars, registration authorities and registration process will be discussed later, in their respective sections.

In the displayed embodiment, a token URI 27, a property from the standard, will also be assigned a value. This value is the location of the metadata file of the ID token 16. This metadata file contains the information about its encrypted identification photo. This will be discussed in detail in a section of ID token creation process below.

The public interface isIdentified( ) 29 is the method to check whether the raw inputs (a person's identity information) match with the hash value stored in the token (ID hash 25). Because only the same input can produce the same hash, this method is used to confirm again whether the person can identify themselves and prove that they are the same individual that created the ID token 16.

The ID token 16 is created (and managed) by a smart contract called a creator smart contract, or creator 20. It should be appreciated by those skilled in the art that, the definitions for all the properties, method(s) of an ID token explained above are, in fact, written in the creator 20 smart contract. When the creator 20 is deployed on the blockchain, it can be used to not only create a new token, but also to read the properties of a particular token or to verify the information the token represents (that is, to identify a person) by calling the interface isIdentified( ). Thus this creator 20 contract and its functions constitute a means for minting new tokens and retrieving values (e.g. id hashes, registrar addresses, etc.) from minted tokens.

### Registry Record

A registry record (or registration record, verification record, record) is another non-fungible token (NFT) that stores a hash value. This hash value is called a registry hash (or registry).

The lower part of FIG. 5 shows a class diagram of the registry record, designed for one embodiment.

In the displayed embodiment, the registry record is based on the standard ERC-721 (similar to the ID token discussed earlier). A registry hash 32 is one of the new properties that is added to the standard one. Another one is a new method named isVerified( ) 33. This method is used to verify if a certain registry hash is already recorded on the blockchain.

Although the exemplary embodiment described herein employs ERC-721, it should also be appreciated by those skilled in the art that other standards like ERC-1155 or similar, might also be used as a base for implementing the registry record. Although, it may or may not implemented on the same blockchain with the ID token, in the current displayed embodiment, both the ID token and the registry record are on the same blockchain.

### Registry Hash

The registry hash is computed from a crypto wallet address and an ID token address. It serves as a matching record of the wallet and the ID token.

The formation of the registry hash in the current embodiment can be described as follows. First, the registrar gets both addresses, the wallet address 30 of the wallet 14 and the token address 31 of the ID token 16. Then, the registrar 18 generates the registry hash 32, by applying a deterministic computation on these two addresses.

In one embodiment, the deterministic computation can comprise the following steps: (1) applying a cryptographic hash function on the wallet address; (2) concatenating the token address to the string which was resulted from the previous step; and (3) applying the cryptographic hash function on the whole concatenated string.

In some other embodiments, the order of the deterministic computation may be different. The registrar can choose to apply the cryptographic function on the token address first, concatenate the result with the wallet address, then hash the whole concatenated string again.

With the cryptographic hash function can be based on one of the security proven standards, including, but not limited to, SHA-256, SHA-512, SHA-3, etc. Currently, the hash function we use in the exemplary embodiment is Keccak256.

Those skilled in that art would be appreciated that, the above computation was provided by way of illustration only and should not be construed as limitation.

The above explanation, for one embodiment, can be easier to understand with the following pseudo-code:

RegistryHash=HASH (TokenAddress+HASH (WalletAddress))

Or, when HASH function is keccak256:

RegistryHash=keccak256 (TokenAddress+keccak256 (WalletAddress))

Or, with a sample code, written in Solidity language:

RegistryHash=keccak256 (abi.encodePacked (TokenAddress)+keccak256 (abi.encodePacked (WalletAddress)))

In the presented code for the embodiment, the Wallet Address is the standard 20-byte long address of a crypto wallet on the blockchain; the Token Address is a 32-byte long value computed by concatenating its creator's smart contract address (20 bytes) with its tokenId number written in hexadecimal format, with the length of 12 bytes. More on Token Address is discussed in Identification Token Address sub-section below.

### Registrar Smart Contract

The registry record is created by a registrar. The registrar is a smart contract on the blockchain that handles registration and identity verification processes. These two processes are discussed in detail in their respective sections.

Similar to the creator smart contract, it should be appreciated by those skilled in the art that, all the definitions and logics explained for a registry record above are, in fact, written in the registrar smart contract. The registrar smart contract can, and is responsible for, not only creating (minting) new registry records on the blockchain, but also for retrieving (reading) registry values from minted records. Thus the registrar smart contract and its functions constitute a means for creating new registry records and retrieving information (e.g. registry hash values) from already minted records.

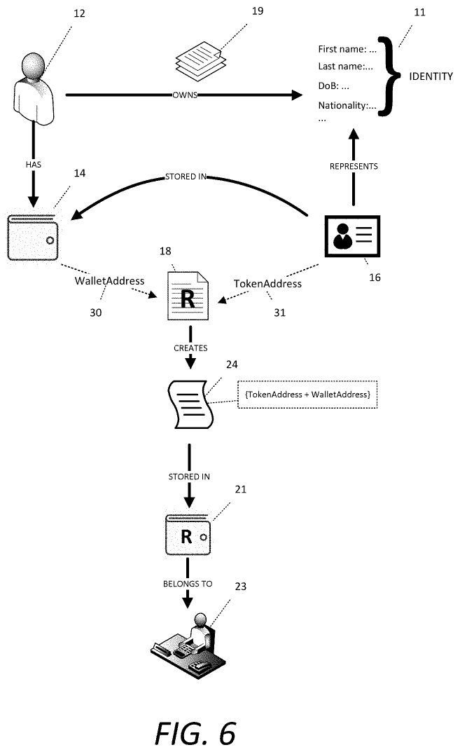

FIG. 6 illustrates more on the registry record and its relationships with other components.

In the displayed embodiment, when the registry record is created by the registrar 18, it will be stored in a crypto wallet 21 of a registration authority (or authority) 23. The authority 23 is the one who confirms all evidence provided by an individual (user) 12 in the registration process, gives authorization (to the registrar 18) to create a new registry record 24 and have responsibility to keep and maintain the record 24 in their wallet 21.

It will be appreciated that, while in some figures or description of figures, we mention “the registrar stores a registry record on the blockchain”, it should be construed, in the displayed embodiment, as “the registrar smart contract stores the registry record in the crypto wallet of the authority, on the blockchain”. Alternatively, in some embodiments, those skilled in the art will readily recognize various ways that the registrar can store the registry record on the blockchain without utilizing, for example, a crypto wallet of an authority.

The existence of the registry record (and its registry hash) on the blockchain is a way of certifying that: 1) the crypto wallet and the ID token (whose addresses were used to create the registry record) and their owner have been verified together; 2) the identity of the owner has been verified with evidence; 3) the identity of the owner matches with the one stored in the ID token; and 4) all of the above have been certified by a trusted party whose crypto wallet is currently holding this registry record.

Therefore, the registry record can be considered as a kind of digital certificate. When an application or service on the Internet sees this certificate, it can be certain that the identity of the user has been verified by an authority. It does not need to go through all the traditional verification process again.

One of the benefits of storing this digital certificate in a crypto wallet controlled by an authority is that, it retains the control in the hand of government bodies. (For example, they have the ability to not only provide new certificates but also to provoke the current ones, by removing the registry records from their crypto wallet). This benefit will help facilitating the application and adoption of blockchain technology in traditional public administration and procedures.

In the following sections, we will discuss some embodiments where an ID token and its system can be used to effectively and quickly identify and verify an identity of a user on Internet.

### Operation

FIG. 1C is a simple visualization of a process by which an ID token is used. When the user 12 wants to use a service provided by an internet application 10, this service may need the person to verify their real-life identity (a). The user then tells the application 10 who they are and displays their ID token (b). The application 10 first checks to see if the information user 12 provided matches with the displayed ID token. If the information matches, then application 10 asks registrar 18 if this identity has already been verified by a trusted authority (c). The registrar 18 then looks for a registry record on the blockchain and answers the application 10 with the result (d). Thus, the real-life identity of the user 12 has been verified without the user 12 needing to provide any scanned documents to application 10, therefore saving time and resources, and reducing the risk of exposing sensitive information to untrusted parties.

FIG. 1B describes the same idea in a form of a flowchart diagram. First, the application 10 asks the user 12 to identify themselves and to verify their identity (step 102). If the user 12 is not currently signed into their wallet 14 (step 104), they will have to do so (step 106) before moving on. After signing in, the application 10 will check if it can find an ID token in the wallet 14 (step 108). If no ID token is found, the user 12 has an option to create a new one in an ID token creation process (2). If an ID token 16 was found in step 108 the application 10 can move on to the identity verification process (4). The ID token creation process and identity verification process will be discussed in their respective sections below.

In order to be effectively used, an ID token needs to be minted (or created) on the blockchain and be registered by a registration authority. In the following sub-sections, we will discuss about these two processes: the ID token creation and registration processes. After that we will discuss about the applications of an ID token, the identification and verification processes.

### Identification Token Creation Process

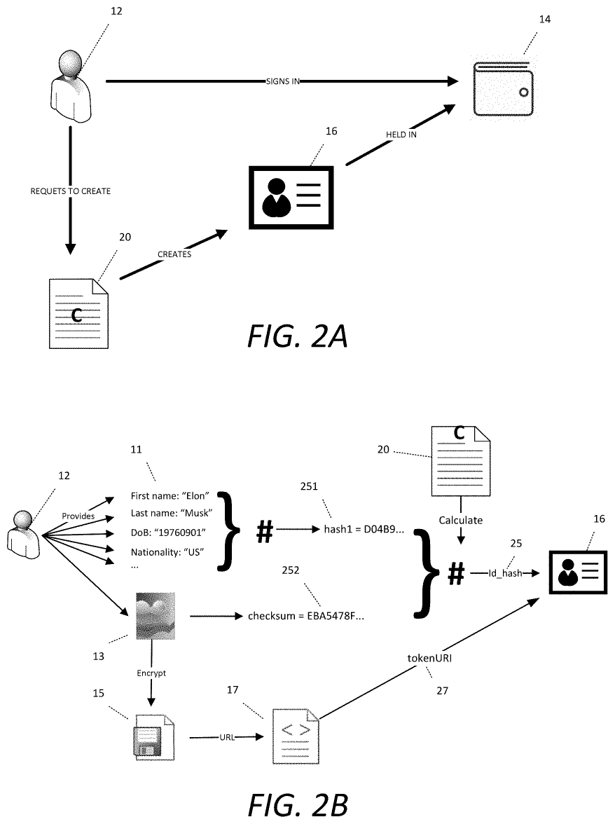

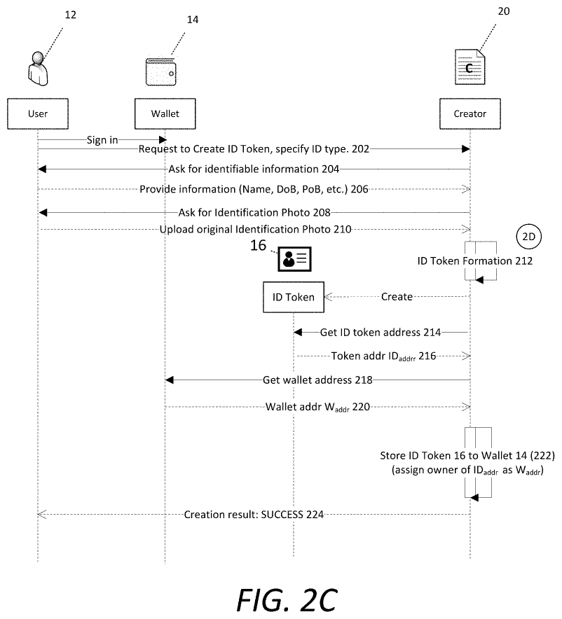

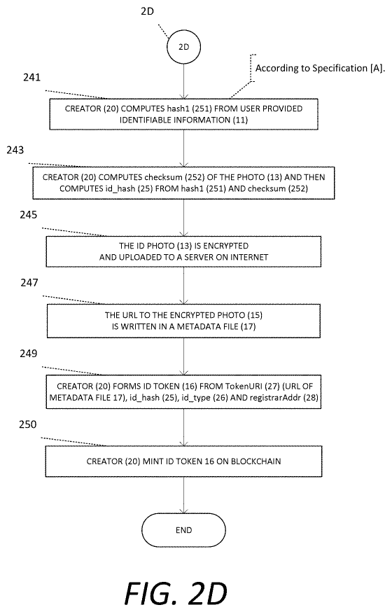

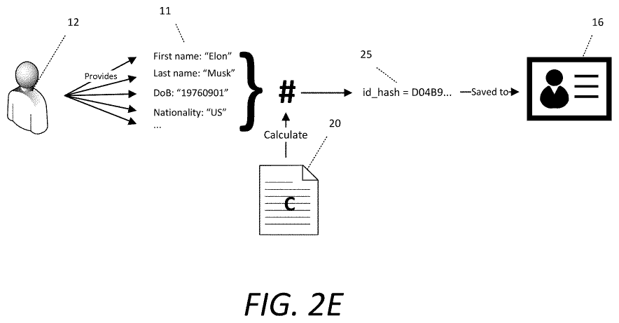

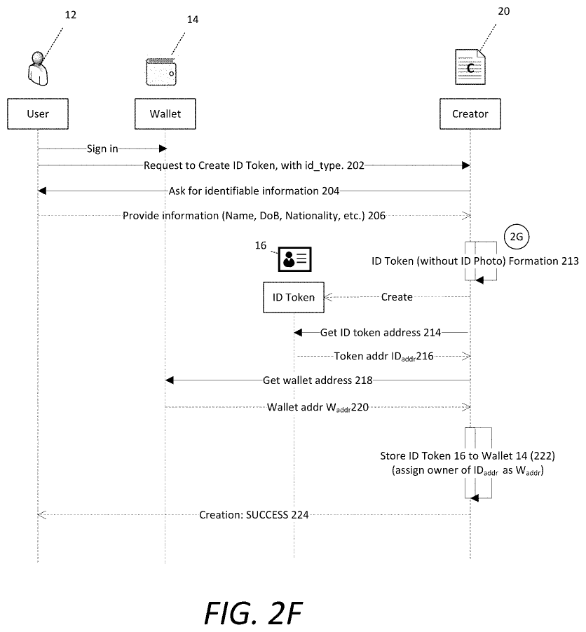

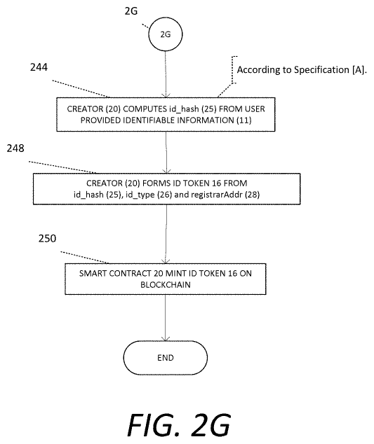

FIGS. 2A, 2B, 2C and 2D show different aspects related to an embodiment of an identification (ID) token creation process.

In the displayed embodiment, an identification (ID) token creation is a process of generating an ID token on a blockchain. It comprises: (1) receiving identification information (or IDI, information) from a person; (2) generating a unique identifier called identification hash (or ID hash) from the IDI; (3) forming an ID token and associating this ID token with the ID hash and other information; and (4) storing the ID token in a crypto wallet (or wallet) of the person.

In one embodiment, the other information includes, but not limited to, an identification type (ID type) and a unique identifier of a registrar, on a blockchain. This unique identifier of the registrar can be an address of a crypto wallet belongs a registration authority, or a smart contract controlled by the authority.

FIG. 2A is an overall view of the embodiment. The User 12 signs into a wallet 14. The user 12 then sends a creation request to a creator 20 smart contract. The creator 20 creates the ID token 16. The creator 20 then stores the ID token 16 in the wallet 14.

FIG. 2C describes the displayed embodiment in more detail with sequential steps.

First, in step 202, the user 12 sends a creation request to the creator 20 specifying the ID type the user wants to create.

Then, in step 204, the creator 20 asks the user 12 to provide their IDI. Based on the ID type, different fields of IDI are asked by the creator 20. The fields of IDI are fields of information that are needed to uniquely identify the user. These includes fields, such as, family name, given name(s), date of birth, place of birth, nationality, etc. and other more sensitive fields, such as ID number, social security number, etc. Specification [A]—Identification Hash Generation below defines these requirements in detail, for the displayed embodiment.

Next, in step 206, the user 12 provides the IDI to the creator 20. The IDI includes the fields that have been requested by the creator 20 in the previous step.

In some embodiments, the user 12 may specify more than one ID type in the request (step 202). In such case, the creator 20 will ask for all the fields of IDI that are needed for those ID types (step 204), still according to the Specification [A].

In the next step 208 of the displayed embodiment, the creator 20 asks the user 12 to provide their identification (ID) photo.

Then in step 210, the user 12 uploads the requested ID photo to a server (not shown). This uploading can be done by using an interface provided by the application or service that is responsible for this creation process. By way of example, and not limitation, such interface can be a web application, a software program run on a personal computer (PC), a smartphone application or any other kind of computer program or system that the user 12 can use to upload the ID photo to the server. The server can be a web server, a file server or any other kind of storage that the creator 20 can access to. The server can be designated by the application or service, or proposed by the user.

In some embodiments, instead of uploading the ID photo to a server, the user 12 can also transferring the photo to the creator 20 by using different methods, including, but not limited to, sending via emails, messaging apps, etc. Those of skill in the art will appreciate that other options may also be used, as long as it provides a way for the creator 20 to access to the original ID photo provided by the user 12.

Then in step 212, the creator 20 forms the ID token 16 based on the information provided by the user 12, including the original ID photo of the user. The formation process is described in more detail in FIG. 2D.

In steps 214 and 216, after an ID token 16 has been created on the blockchain, the creator 20 may obtain the token address. At these steps, the internal id (tokenId) of the ID token may be needed, but not the full token address; since the full address contains the address of the creator smart contract which is not needed for the creator itself. More on ID token address is discussed in Identification Token Address sub-section below.

In steps 218 and 220, the creator 20 gets the wallet address of the wallet 14.

In step 222, the creator 20 will assign the wallet 14 as the owner of the newly created ID token 16. In other words, the creator 20 stores the ID token 16 in the wallet 14.

Finally, in step 224, the creator 20 may send the result back to the user 12.

### ID Token Formation

FIG. 2D is a flowchart describing in more detail the ID token formation sub-process (step 212 in FIG. 2C above).

In step 241, the creator 20 computes a value called hash1 (251) from the user-provided IDI 11, based on their desired ID type 26 (not shown). As discussed earlier, this computation is defined in Specification [A]—Identification Hash Generation, except that instead of assigning the result of the computation directly to the ID hash 25, as mentioned in the specification, the creator 20 will assign the result to hash1 (251).

Next, in step 243, the creator 20 gets the checksum (e.g. MD5) 252 of the original identification photo 13. Then the creator 20 uses the checksum 252 and the hash1 (251) from the previous step, applying a deterministic algorithm, to compute the ID hash 25.

In some embodiments, the deterministic algorithm above may comprise: (1) concatenating the checksum 252 next to the hash1 (251); then, (2) applying a cryptographic hash algorithm on the concatenated string.

The cryptographic hash algorithm can be the same hash algorithm used in step 241 or it can be any other hash algorithm based on a different standard. For example, the standard can be one of the algorithms, including, but not limited to: SHA-2 (i.e., SHA-224, SHA-256, SHA-384, SHA-512, SHA-512/224 and SHA-512/256) or SHA-3 (i.e., SHA3-224, SHA3-256, SHA3-384, SHA3-512, SHAKE128 and SHAKE256).

Continue with the FIG. 2D, in step 245, the original ID photo 13 is encrypted, and the encrypted photo 15 is then uploaded to a server on the internet.

In some embodiments, the encryption algorithm used for encrypting the ID photo 13 can be symmetric, asymmetric, or a combination of symmetric and asymmetric encryption.

By way of example, and not limitation, such symmetric encryption can be Data Encryption Standard (DES) algorithm, 3DES algorithm, Triple Data Encryption Algorithm (TDEA) algorithm, Blowfish algorithm, Rivest Cipher 5 (RCS) algorithm, International Data Encryption Algorithm (IDEA) algorithm, etc.; and such asymmetric encryption can be Rivest-Shamir-Adleman (RSA), Elgamal, backpack algorithm, Rabin, D-H (Diffie-Hellman key exchange), ECC (Elliptic Curve Encryption Algorithm), etc.; or a combination of symmetric encryption and asymmetric encryption called Digital Envelope encryption method.

In one embodiment, the server is a Web server designated by the creator 20. The server is usually controlled and managed by the same one who controls the creator 20. In some embodiments, the server can be any other kind of server, as long as the creator 20 has permissions to store a file and/or download the file from there.

In step 247, the creator 20, gets the URL of the encrypted photo 15. The creator 20 then uses the URL to form a metadata file 17, and stores the file 17 on a server.

Note that, the server used to store the metadata file 17 can also be a Web server but it does not need to be the same server as the one used for storing the encrypted photo 15.

In some embodiments, the encryption and uploading of the ID photo 13, and the generation and uploading of the metadata file 17 can be done by a computer program, an application or any other type of software or hardware that are capable of handling the tasks.

The path to the metadata file 17 is then assigned to a token URI 27. This path is usually an URL.

In step 249, creator 20 then forms an ID token 16 from the token URI 27, ID hash 25, ID type 26, and a registrar address 28.

In one embodiment, the registrar address 28 is the crypto wallet address of the authority that will verify the identity of the user 12. The creator 20 can select the value of the registrar address 28 from a known list of trusted authorities and their crypto wallet addresses. This selection can be done based on some criteria defined by the creator 20, such as the type of the identity, the nationality of the user, etc.

In some embodiments, the registrar address 28 can be an address of a smart contract which is managed by the trusted authority.

Finally, in step 250, the creator 20 mints the ID token 16 on the blockchain, finishing the sub-process of ID token formation. In this step creator 20 may assign the owner (or holder) of the ID token 16 is the wallet 14 of the user 12.

With reference to FIG. 2B, a simplified visualization of the process is shown. The creator 20 computes hash1 (251) from the IDI 11 provided by the user 12. Then ID hash 25 is computed from hash1 (251) and the (MD5) checksum 252 of the original ID photo 13. At the same time, the original ID photo 13 is encrypted and uploaded to a server. The location of the encrypted photo 15 is used to create a metadata file 17. Then the token URI 27, the location of the metadata file 17, is used together with the ID hash 25 to form the ID token 16. Note that, the ID type 26 and the registrar address 28 are not shown. However, they were already mentioned in detail in the previous paragraph.

Next, we will discuss more on two topics. The first one is the address of the ID token (Token Address) on a blockchain. The second one, Specification [A], is the proposed rules, for one embodiment, of how to generate the identification hash (ID hash) from the IDI, based on different types of identification (ID type).

### Identification Token Address

In a standard non-fungible token (NFT) (e.g. ERC-721) smart contract, there is one member called tokenId. The tokenId is an unsigned integer member that represents the id of the NFT within the smart contract. As standard, once a new token is created by the smart contract, this tokenId will be increased by 1, and assigned to the new token as its id. The combination of the smart contract's address with the id of the token is used to distinguish tokens and uniquely identify the token on the blockchain.

However, to increase the convenience, instead of giving two separate values (one for the smart contract, the other for the tokenId) to indicate an ID token, I combined these two values in one single address. The Identification token address is a 32-byte hexadecimal string value computed by concatenating its creator contract address (20 bytes) with the tokenId, wherein the tokenId is formatted as a 12-byte hexadecimal string.

The following piece of code, written in Solidity language, demonstrates the explanation above.

| | |
|---|---|
| private val FULL_LEN = 64 | // 32 bytes |
| private val TOKENID_LEN = 24 | // 12 bytes |

IDTokenAddress : String = (creator.toString( ) +
tokenId.toHexString( ).padStart(TOKENID_LEN, ‘0’)).padStart(FULL_LEN, ‘0’)

When we want to extract the creator smart contract address and the tokenId from the ID token address, we can do as follows.

The creator address can be extracted from the ID token address by extracting its most-left 20 bytes:

creatorAddress=address(uint160(bytes20(IDTokenAddress)));

The tokenId can be extracted from the ID token address by extracting its most-right 12 bytes (or 96 bits):

tokenId=uint96(uint256(IDTokenAddress));

### Specification [A]—Identification Hash Generation

This sub-section describes in more detail, for an embodiment, the generation of the identification hash (ID hash).

This generation takes the user-provided identification information (IDI) as input. Based on different identification (ID) types, it will produce different ID hashes. Thus the system and method explained below constitute a means for generating an ID hash from IDI.

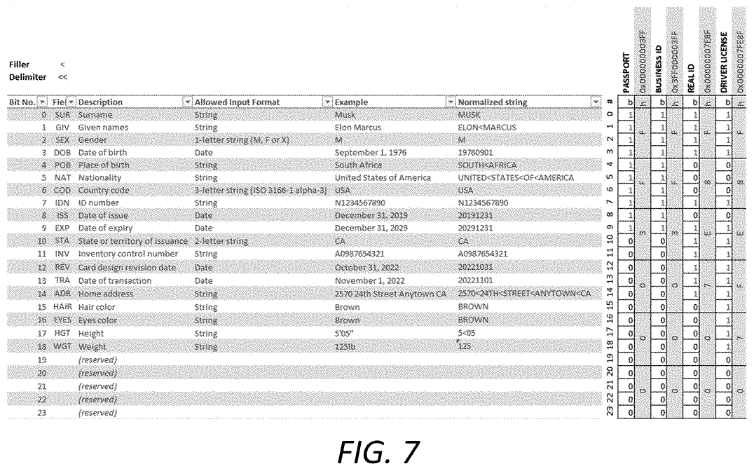

FIG. 7 will be used for the discussion.

In real-life, a person can have many different ID cards (or IDs), such as a passport, a driver's license or other types of ID. They can use one of these IDs for identification purposes. The same idea can be applied for ID tokens.

In an embodiment, one ID token can be made to represent a certain type of personal ID. Additionally, one ID token can also represent another type of non-personal ID, such as, a legally recognized business entity, or a license of ownership of a tangible asset like a house, or a car, etc.

The identification type (ID type) defines what kind of ID the token represents. It also defines what kind of information (or what fields of IDI) will be needed in order to generate the ID hash. Some examples of a field of IDI are surname, given name(s), date of birth, place of birth, nationality, etc.

Because generating the ID hash is a step involved in many processes, such as, Identification Process or Identification Token Creation Process, we need to design a novel system so that the ID hash can be generated correctly and timely. The design should also be able to reduce the risks of human or system errors. For example, these errors could occur due to the complexity in the rules, or the algorithms, used in the system. So the algorithms should be compact, but clear and precise enough so that a simple computer-based program can implement it effectively.

In one embodiment, the novel system is designed as follows.

The generation of the ID hash comprises at least the following steps: (A) deciding what fields of IDI are needed; (B) arranging the information for these needed fields in a string, following a specific order; and (C) applying a cryptographic hash algorithm on the string. The result of the final step is the ID hash.

For the first step (A), the ID type is used for deciding what fields of IDI are needed. The ID type is an N-bit number. In the current embodiment, I choose N=256. When the ID type is presented in a binary form, it contains 256 bits, each bit is either 0 or 1.

The position of each bit is numbered, with bit no. 0 is the most right (least significant) bit of the ID type. And bit no. 255 is the most left (the most significant) bit of the ID type. Each bit represents the setting for one field of IDI, where the setting is either “needed” or “not-needed”. If the bit equals 1, the field of IDI is needed; if it equals 0, the field of IDI is not needed.

For example, the mappings between the setting bit numbers (the positions of the bit) and the fields of IDI, for the first 19 bits, are shown in a table in FIG. 7. The rest of the setting bits (bit no. 19 to no. 255) are not shown.

Given a certain number for the ID type, referring to the table, one can quickly determine the exact fields of IDI needed, by doing the steps comprising: (A1) converting the ID type to its binary form; (A2) matching the positions of the bits 1, in the binary form of the ID type, with the table in FIG. 7, to identify which fields of IDI are needed.

For example, with ID type equals 15 (or 0xF in hexadecimal format). Converting the ID type to its binary form gives us 1111. That means, bits no. 0, 1, 2 and 3 all equal 1. Referring to the table in FIG. 7, one can see that the following fields of IDI are needed: SUR (Surname), GIV (Given names), SEX (Gender) and DOB (Date of birth).

For the second step (B), arranging the needed fields of IDI in a string. The string, named Info String, is an ordered string that is formed from the IDI provided by the user. An ordered string means it is formed by putting some other strings, e.g. fields of IDI, in a specific order.

In one embodiment, the Info String is formed by: (B1) putting the user-provided IDI for all needed fields next to each other, in the same order as their presenting bits (meaning, the first field will start first, on the left of the Info String); and (B2) formatting each and all the fields following a set of formatting rules.

In one embodiment, the formatting rules comprises: (B2.1) all fields are separated by a delimiter; the delimiter is formed by two fillers; (B2.2) the filler is one “<” character; (B2.3) all fields should keep alpha numeral characters and single spaces between words, but all hyphens, apostrophes, quotes, redundant spaces and other special characters should be removed; (B2.4) all formatted in uppercase, spaces converted to fillers.

In some other embodiments, another non-alphanumeric character can be used as a filler. And the delimiter can be other characters rather than two fillers.

For example, with the sample IDI presented in the table in FIG. 7, and the example of ID type (equals 15) above, the Info String would be:

MUSK<<ELON<MARCUS<<M<<19760901

And, for the type PASSPORT (idType=0x03FF) in the table, the Info String would be:

MUSK<<ELON<MARCUS<<M<<19760901<<SOUTH<AFRICA<<UNITED<STATES<OF<AMERICA<<USA<<N1234567890<<20191231<<20291231

Although specific rules were provided, for the step (B) of arranging needed fields of IDI in a string, it will be appreciated that those should not be construed as limitations but are provided by way of illustration only. Those skilled in the art will recognize that many other rules can also be applied, for some embodiments.

Regarding the third step (C), the ID hash will be calculated by applying a cryptographic hash algorithm on the Info String. This hash algorithm can be based on one of the standards such as SHA-2 or SHA-3. In the displayed embodiment, I choose Keccak256.

Continue with the examples, the ID hash for the ID type 0xF would equal to:

keccak256(“MUSK<<ELON<MARCUS<<M<<19760901”)

And, for the ID type 0x03FF, of the same IDI, the ID hash would equal to:

keccak256(“MUSK<<ELON<MARCUS<<M<<19760901<<SOUTH<AFRICA<<UNITED<STATES<OF<AMERICA<<USA<<N1234567890<<20191231<<20291231”)

However, in will be appreciated that another deterministic algorithm may also be used in the step (C), to calculate the ID hash, as long as the algorithm provides the same characteristics as a cryptographic hash functions does.

By applying the deterministic algorithm, e.g. a cryptographic hash function, on a formalized string of IDI, we make sure that: 1) the same ID hash can only be reproduced by supplying the same IDI, and 2) variations of the same IDI (e.g. in format) will not cause it to produce different hashes. For example, with this method, “Elon Musk” and “ELON musk” (with extra spaces and differences in case sensitivity) will produce the same hash. Therefore it helps avoiding mistakes caused by humans or machines in the operations, while still keeping the characteristics of a hash function, which include integrity and authenticity.

After creating an ID token, the user needs to ask a trusted authority to validate the information that the ID token represents, and register it with the user's crypto wallet. The process is called ID token registration, explained in the section below.

### Identification Token Registration Process

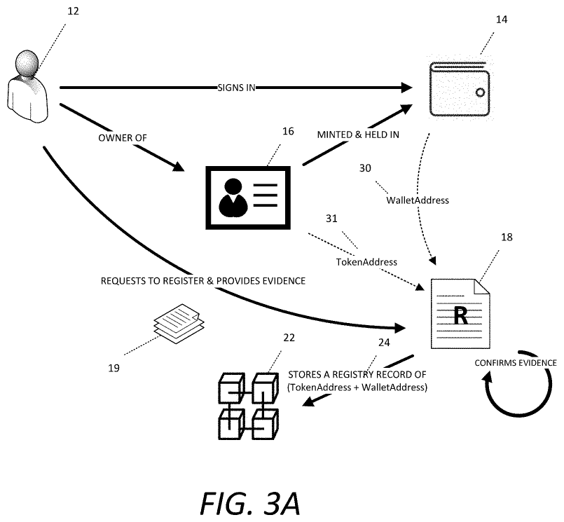

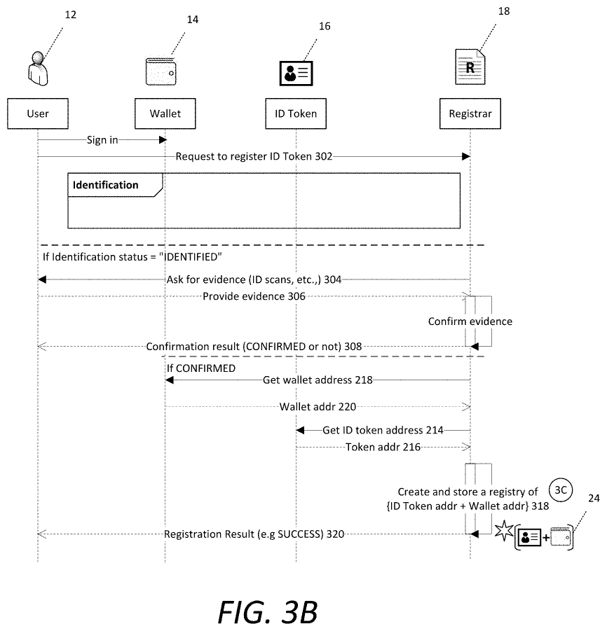

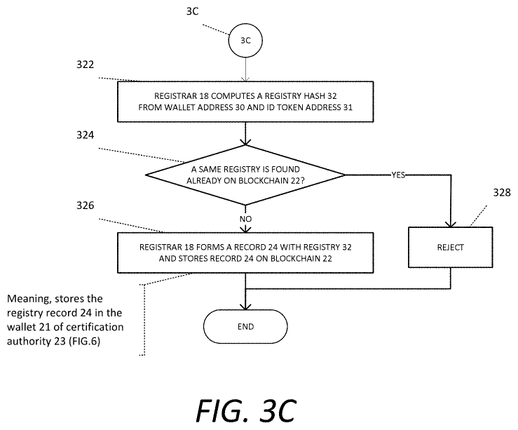

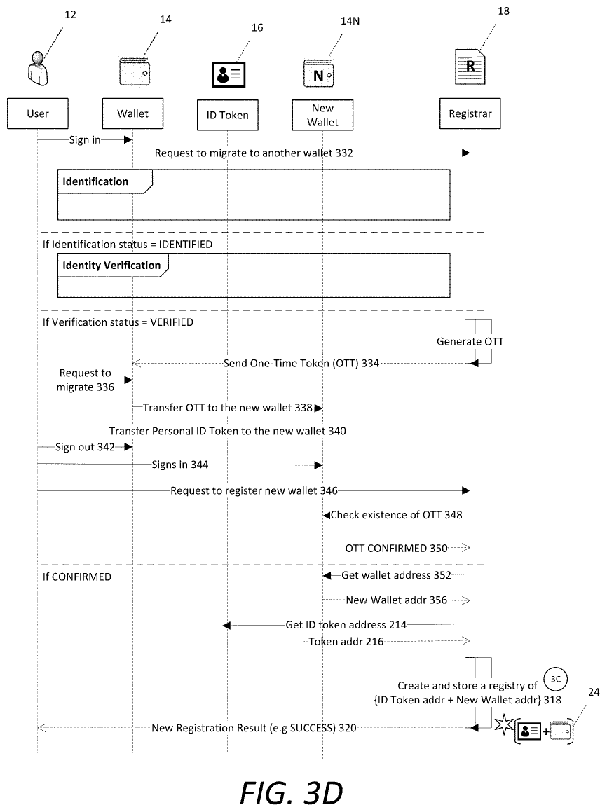

FIGS. 3A to 3D show different aspects related to an embodiment of an identification (ID) token registration process.

In the displayed embodiment, the ID token registration process is a process of registering an ID token with its authorized wallet, and keeping a registration record on a blockchain.

In the embodiment, the authorized wallet of an ID token means that the owner of the wallet is also the authorized owner of the identity that the ID token represents. In other words, whoever controls the wallet has the identity that has been verified by the authority.

In order to complete the registration process, the owner of the wallet needs to prove that they are indeed the person they claim to be, by providing all of evidence, usually government-issued documents (such as ID scans, birth certificates, etc.) to the registration authority. After confirming all of the evidence, and checking if the information in the evidence is valid and matches with the information provided by the user, as well as with the information stored in the ID token, the registration authority will then create a permanent record on the blockchain. This record, called a registry record, is a way of confirming that the identity of the user has been verified by the authority.

In FIG. 3A, an overall view of the embodiment where the registration process is used. The user 12 sends a request to the registrar 18, asking to register the ID token 16 with the wallet 14. Along with the request, the user 12 also provides the registrar 18 with all the documents (evidence 19) to prove their identity. The registrar 18 confirms the evidence 19, forms a registry record 24 from wallet address 30 and token address 31, and stores the record 24 on the blockchain 22.

In the displayed embodiment, the process involves a registrar 18 doing the following steps: (1) getting a wallet address 30 of the crypto wallet 14, and the token address 31 of the ID token 16; generating a registry hash (not shown) from the wallet address 30 and the token address 31, by applying a deterministic computation; and (3) storing the registry hash on the blockchain.

In an embodiment, the registrar can mint (or create) a new non-fungible token (NFT) called a registry record (or record) 24, and associate the registry hash to the record.

In an embodiment, the deterministic computation can be a cryptographic hash algorithm based on one of the standard algorithms, including, but not limited to: SHA-2 (i.e., SHA-224, SHA-256, SHA-384, SHA-512, SHA-512/224 and SHA-512/256) or SHA-3 (i.e., SHA3-224, SHA3-256, SHA3-384, SHA3-512, SHAKE128 and SHAKE256), or any combination thereof.

In some embodiments, the deterministic computation can also be one of, or a combination of one of, the cryptographic hash standards with one or some of other deterministic computation rules, such as string manipulation, etc.

Keccak256, a SHA-3-based hash algorithm is used for the exemplary embodiment. However, those of skill in the art will be appreciated that many other options are also possible, as long as they provide a deterministic method to produce a unique and deterministic value from two other values.

With reference to FIG. 3B, the same process is presented as a sequence diagram.

In step 302, when the user 12 sends a registration request to the registrar 18, the registrar 18 first needs the user 12 to identify themselves. The purpose of this step is to identify the person and confirm whether they have a valid ID token or not. This identification process will be discussed in detail in the next section.

In step 304, provided that the user 12 has been identified, the registrar 18 will ask the user 12 to provide all the evidence to prove their identity.

In step 306, the user 12 provides these documents. The registrar 18 then checks the evidence. If the evidence is confirmed, the registrar 18 will start creating a registry record 24.

To do that, in steps 218 and 220, the registrar 18 will get the wallet address from the wallet 14; and, in step 214 and 216, the registrar 18 gets the token address 31 from the ID token 16.

Then, in step 318, the registrar 18 uses these two addresses to create the registry hash (not shown) and the registry record 24 and stores it on the blockchain. This step of creating and storing the registry record is marked by the circled 3C in FIG. 3B, indicating that more details are presented in FIG. 3C below.

FIG. 3C is a flowchart showing the steps that registrar 18 needs to follow in order to create a registry record 24.

First, in step 322, it compute the registry hash (registry) 32 from the wallet address 30 and the token address 31. As explained earlier, this computation is based on a deterministic algorithm. In the embodiment, I choose Keccak256 cryptographic function, however, those of skill in the art will be appreciated that many other options are also possible.

Next, in step 324, the registrar 18 checks to make sure that the same registry 32 is not there already on the blockchain 22. If the same registry has been found, the registrar will reject the request from the user 12 (step 328). If there is no such registry on the blockchain yet, in step 326, the registrar 18 will continue to form the registry record 24 from the registry hash 32 and store the record 24 on the blockchain 22.

As mentioned earlier, when storing the record 24 on the blockchain 22, the registrar 18 can choose to store the record 24 in a crypto wallet 21 of a registration authority 23. Alternatively, in some embodiments, those skilled in the art will readily recognize various ways that the registrar can store the registry record on the blockchain without utilizing, for example, a crypto wallet of an authority.

In one embodiment, an ID token may be created once, but the same ID token can be registered many times with many wallets (provided that the owner has authorized access to those wallets). Once the ID token is transferred to another wallet, different from the one it was initially registered with, it may have to register it again with the new wallet. The process of registering with the new wallet (or migrating) is described below (FIG. 3D).

### ID Token Migrating Process

FIG. 3D is a flowchart describing a process, in an embodiment, when the user 12 wants to register an ID token 16 with a new wallet (14N). Note that, the ID token 16 has been successfully registered with the original wallet 14. This process is slightly different from the normal registration process. In the normal process, as described earlier in FIG. 3B, the user 12 needs to provide all evidence to the registrar 18 in order to prove their identity. However, this time, that evidence confirmation step can be skipped thanks to the Identity Verification Process (described below). Detail of the migrating procedure is described as follows.

In step 332, the user 12 sends the request to the registrar 18. The registrar will then ask the user 12 to identify themselves and verify their identity. These can be done through both the Identification Process and the Identity Verification Process. These two processes are discussed in detail in the following sections.

At step 334, after the user 12 has successfully identified (and verified) themselves, the registrar 18 generates a One Time Token (OTT) and gives it to the user 12, by transferring it to the wallet 14. This OTT is a short-term certification, or pass, that certifies the user 12 has been successfully identified and their identity has been verified by the registrar 18.

Next, in step 336, user 12 sends a request to migrate to wallet 14. And in steps 328 and 330, the wallet 14 will then transfers both the ID token 16 and the OTT to the new wallet (14N).

Next, in step 342, the user 12 signs out of the wallet 14 and signs into the new wallet (14N) (step 344), to continue the process from there.

In step 346, the user 12 then sends a new registration request from the new wallet (14N) to the registrar 18, asking to register the ID token 16.

In steps 348 and 350, the registrar 18 sees that new wallet (14N) is holding the short-term OTT that the registrar 18 has provided user 12 earlier, it has the confidence that the owner of new wallet (14N) is also the owner of wallet 14.

Therefore, the registrar 18 will start creating and storing a new record 24 for ID token 16 and new wallet (14N), without asking the user 12 to provide any evidence. The rest of the process, creating and storing the registry record 24 is the same as the one described in FIGS. 3B and 3C earlier.

In the embodiments shown, the result of this registration process is the registry record on the blockchain. By checking the existence of this record, internet applications or services can quickly and reliably verify the identity of a user without going through all the procedures, which have been done thoroughly by the trusted authority, again. This saves time and effort, avoids human or system errors, and reduces the risks of undesired exposure of information by the mishandling of confidential data. We will discuss more about this in the section of Identity Verification Process below.

In the following section, we will discuss another use-case with the ID token, the Identification Process.

### Identification Process

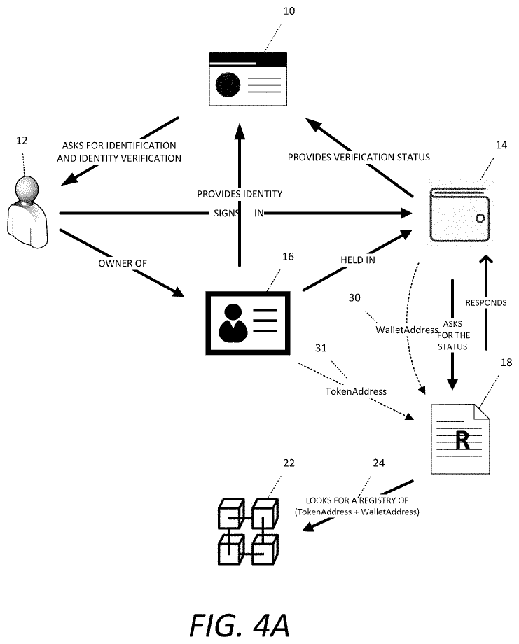

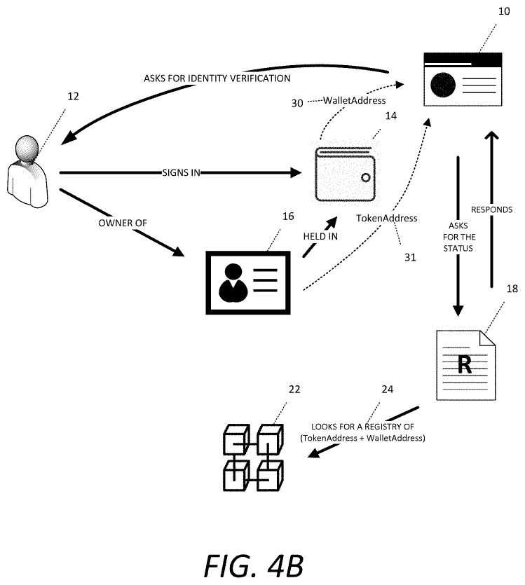

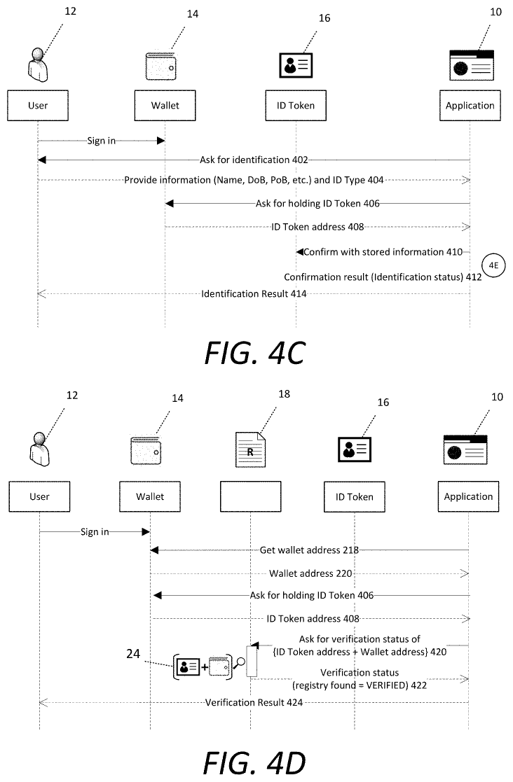

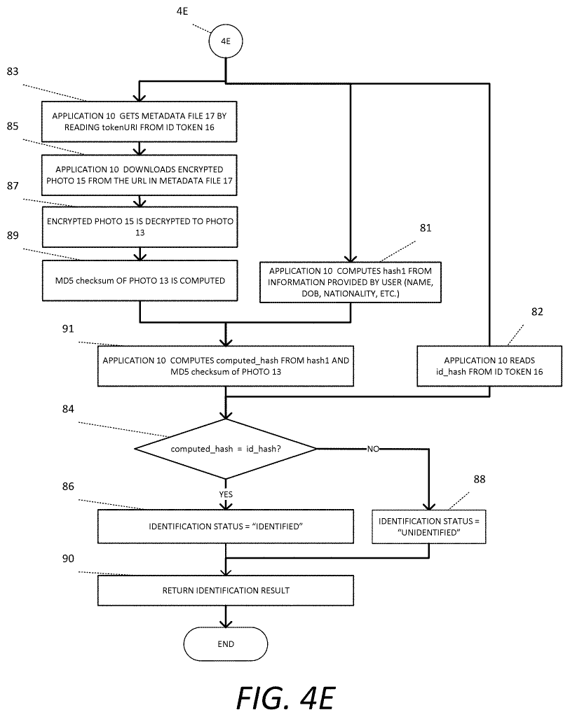

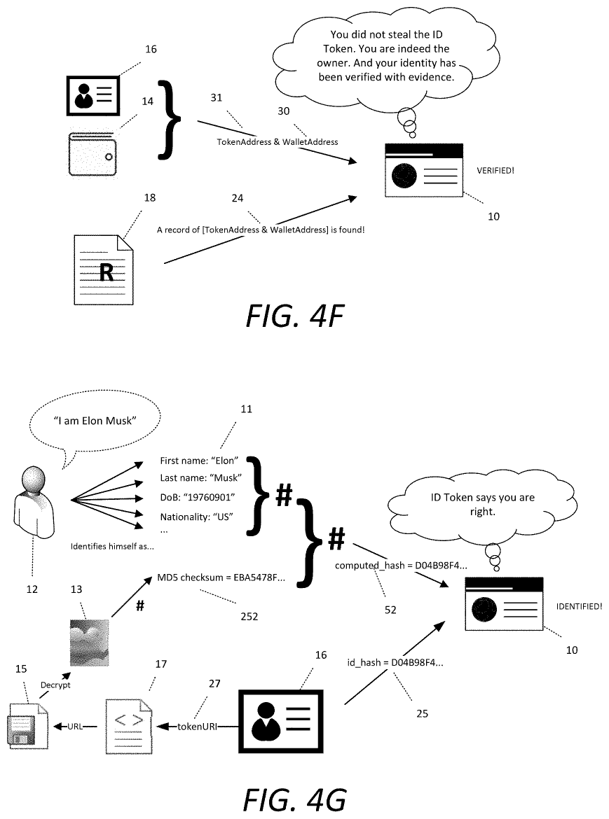

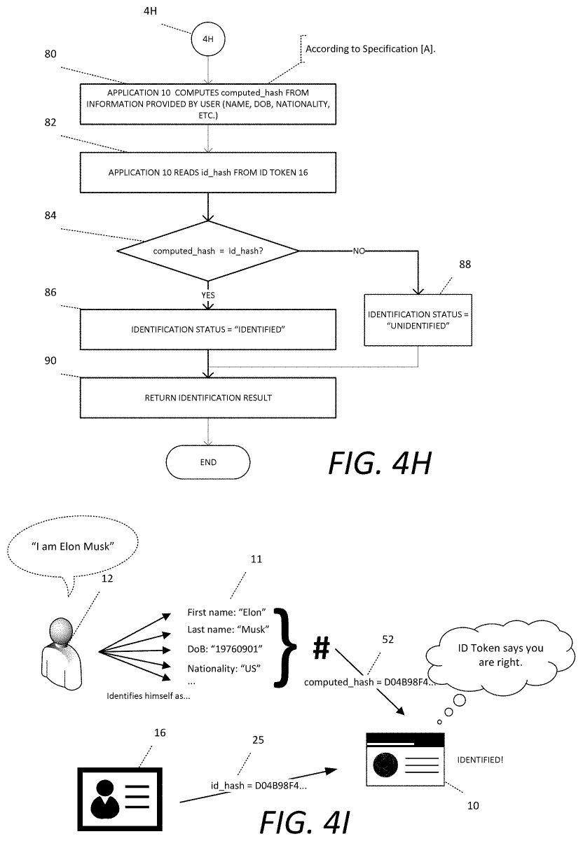

FIGS. 4A, 4C, 4E and 4G show different aspects related to an embodiment of an identification process.

In the displayed embodiment, identification process is a process of identifying a person and confirming whether they have a valid ID token for the service they wish to use. An ID token is viewed as valid if it stores the same information about the identity that the person claims to have.

This process can be used by an actor (a crypto wallet, an internet application or service) that has access to the blockchain. The process comprises, (1) asking the user to provide, and receiving from them, a set of identification information (IDI); (2) computing a hash value from the IDI, by applying the same deterministic computation that is used in the ID token creation process; and (3) checking if the computed hash value and the ID hash stored in the ID token are correlated (e.g. comparing these values).

This set of IDI is usually confidential, part of it is private and is not known by others than the person. Because of the characteristics of the deterministic computation (e.g. a cryptographic hash algorithm), the same output can be produced only if the same input is provided, if the computed hash and the ID hash match (or are correlated), the actor (internet application or service) can be certain that the person is the one who created the ID token. In other words, the user has the same identity as stored in the ID token; or the user is correctly identified.

FIG. 4A shows the overall view of an embodiment where the identification process can be used. The process involves the actor; in this case the application 10, asking the ID token 16 whether the information provided by the user 12 matches with the information stored in ID token 16.

FIG. 4C is a sequence diagram describing the identification process in detail.

First, in step 402, the application 10 asks the user 12 to identify themselves.

Then in step 404, the user 12 provides a set of IDI together with its corresponding ID type. This set of IDI may include the family name, given names, date of birth, place of birth, nationality etc. depending on the ID type, as described in the Specification [A]—Identification Hash Generation earlier. The ID type is provided in order for the actor to recreate the ID hash (now called computed hash) correctly, from the correct fields of IDI.

Next, in steps 406 and 408, the application 10 retrieves the ID token 16 that is currently held in the crypto wallet 14. The crypto wallet 14 is the one that is currently being used by the user 12.

Then, in steps 410 and 412, the application 10 confirms with the ID token 16 whether the IDI provided by the user 12 is the same as that stored in the ID token 16. This confirmation step is represented by a circled 4E in FIG. 4C, indicating that more details are described in FIG. 4E below.

FIG. 4E is a flowchart shows the steps that the application 10 takes in order to confirm the user-provided IDI with the information stored in the ID token 16.

First, in step 81, the application 10 computes a hash1 value from the user-provided IDI.

At the same time, or in no specific order, in step 82, the application 10 reads from the ID token 16 the stored ID hash value.

At the same time, or in no specific order, in step 83, the application 10 also reads from the ID token 16 the token URI. Then using the token URI, application 10 retrieves a metadata file 17.

Then, in step 85, by reading the URL in the metadata file 17, the application 10 downloads the encrypted photo 15.

Next, in step 87, the encrypted photo 15 is decrypted to the original photo 13. Note that, in this step, the decryption can be done either by the application 10, or done by the wallet 14 itself. Also, the decryption should be based on the same algorithm that has been used in the ID token creation process (step 245, FIG. 2D).

As discussed in the creation process, in some embodiments, the algorithm could be symmetric, asymmetric, or a combination of symmetric and asymmetric encryption.

Next, in step 89, the checksum (e.g. MD5) of the photo 13 is computed. Again, this computation can be done either by the wallet 14 or the application 10, depending on who did the decryption and has control over the decrypted photo.

In step 91, the application 10 computes the computed hash from the hash1 value (in step 81 above) and the checksum, using the same deterministic algorithm that has been used in the ID token creation process (step 243, FIG. 2D).

In step 84, the computed hash will then be compared with the ID hash (read from step 82 above).

If they equal, the application 10 will set the identification status as “IDENTIFIED”, in step 86. If they do not equal, the application 10 will set the identification status to any other value than “IDENTIFIED” (such as, “UNIDENTIFIED”), in step 88.

Finally, in step 90, the application 10 returns the result to the user 12, and finishes the operation.

In some embodiments, instead of directly computing the computed hash and comparing it with the ID hash in ID token (16), as explained above, the application 10 can also call a public function of the ID token 16, named isIdentified( ), provides it with the ID as a parameter, to get the identification result.

In some embodiments, instead of using comparison as a rule to check if the computed hash and the ID hash are identical, another deterministic rule may also be used. By way of example, and not limitation, such deterministic rule can comprise an arithmetic rule, a logical rule, a rule involves a cryptographic algorithm, a string-manipulation rule or any other matching rule which can deterministically decide whether and the computed hash and ID hash are correlated.

For visualization and a better understanding of the identification process, the exemplary embodiment is simplified as shown in FIG. 4G. The person (12) makes a claim of their own identity, and then provides all of the details they know about this identity. The application 10 then uses this set of information to confirm with the ID token 16. It they match, it means the person is holding a valid ID token for the identity that they claim.

With the embodiment disclosed in this section, the identification process can helps identifying a person not only by textual information, but also by visual confirmation. It adds one more security layer to the traditional identification process, whether it is online or offline. (For example, with “offline” use-case, the person can use their smartphone application, which has their crypto wallet and its associated security keys, to decrypt the ID photo, and show this decrypted photo to the other person that is requesting the user for identification. Note that, “offline” in this context doesn't mean “without Internet connection”, but rather means “physical or real-life interactions”. One example for this kind is access management for a building or a venue).

In some use cases, the identity also needs to be verified (for example, to make sure it is real, and/or legally recognized by governments or trusted authorities), the application will need to rely on the process of identity verification below.

### Identity Verification Process

FIGS. 4A, 4B, 4D and 4F show different aspects related to an embodiment of an identity verification process.

In the displayed embodiment, the identity verification process is a process to confirm whether the identity of a user has been verified by an authority. It is conducted by looking for a registry record on the blockchain that matches the ID token of the user with the crypto wallet the user is currently using. If such a registry record exists, it means two things. First, the identity of the user has been confirmed by the authority. Second, the wallet the user used at the time of registering with the authority was the same one as the one they are currently using.

In some embodiments, instead of looking for the registry record, one can directly look for a registry hash which is computed from the wallet address and the token address, by applying the same deterministic computation used in the registration process (explained in a sub-section of Registry Hash above).

FIGS. 4A and 4B show the overall view of an embodiment where the identity verification process can be used. While in FIG. 4A, crypto wallet 14 is the one responsible asking and getting verification status from the registrar 18; those tasks can also be done directly by the application 10 without consulting the wallet 14, as can be seen in FIG. 4B.

In the displayed embodiment, the identity verification process comprises at least the following tasks: (A) generating a computed registry hash from the wallet address and the token address; and (B) searching for the existence of the registry hash on the blockchain.

In one embodiment, the searching step (B) may also comprise: (B1) getting the address of the registrar from the ID token; and (B2) asking the registrar, at that registrar address, whether they are storing the same registry hash.

Furthermore, in some embodiments, the step (B2) above may also comprise: (B2.a) listing all registry records that are currently being held at the registrar address; and (B2.b) checking if any of these registry records having a registry hash which is the same or correlated to the computed registry hash.

FIG. 4D is a sequence diagram describing the process in the described embodiments.

First, in steps 218 and 220, the application 10 gets the wallet address of wallet 14. Wallet 14 is the crypto wallet user 12 has signed in and currently using.

Next, in step 406, the application 10 checks if there is any ID token that wallet 14 is currently holding. If no ID token has been found in wallet 14, application 10 quit the process; the identity of the user 12 has not been verified.

If there is one ID token in wallet 14, application 10 asks for its token address, at step 408.

Then, in step 420, the application 10 sends both of these addresses, of the wallet 14 and of ID token 16, to the registrar smart contract (18) and asks for their verification status.

Now, at this point, the registrar smart contract (18) will follow the steps described above: (A), then (B1), (B2.a) and (B2.b), to search for the registry record of the wallet address and the token address.

In step 422, if the record 24 or the registry hash 32 is found, the registrar 18 returns the verification status as “VERIFIED” to the application; the identity of the user 12 has been verified. If neither the record 24 nor the registry hash 32 has been found, the registrar can send any other value than “VERIFIED” (e.g. “NOT-VERIFIED”) to the application 10; the identity of user 12 is not verified.

For visualization purpose, the identity verification process is simplified in FIG. 4F.

The application 10 gets the wallet address 30 and the ID token address 31. Then it asks the registrar 18 for the existence of this matching record on blockchain. The registrar 18 does the search and returns the result to the application 10. If the record has been found, the application 10 can be certain that the wallet (and therefore the user) is an authorized owner of the ID token 16 and that this has been confirmed with evidence by a trusted authority.

This process can be used by a crypto wallet, an internet application, or a service that has access to the blockchain. It helps the wallet, application or service to verify identity of the user without going through all the procedures that have been done thoroughly by the trusted authority, therefore saving time and effort, reduce human or system errors, and the risks of exposing by mishandling confidential data.

Alternative Embodiment—ID Token without ID Photo

Alternatively, in some embodiments, the identification (ID) token can also be created and used without an ID photo, as being described in FIGS. 2E, 2F, 2G, 4H and 4I.

In the creation process of the displayed embodiment (FIGS. 2E, 2F and 2G), most of the steps in the sequence diagram in FIG. 2F are similar to the ones in FIG. 2C, except that: 1) there are no steps of asking for the ID Photo (steps 208, 210 in FIG. 2C), and the step of ID token formation are now different (step 213 in FIG. 2F).

The FIG. 2G is the flowchart depicting the step 213 (FIG. 2F) in more detail. As illustrated, the identification information is used by the creator 20 to create the ID hash 25. No checksum of a photo is needed. The same can also be seen in the visualization in FIG. 2E.

Similarly, in the identification process (FIGS. 4H and 4I), the application 10 can compute the computed hash from the IDI provided by the user 12, and compare it directly with the ID hash in the ID token. No work regarding downloading, decrypting photos will be needed.

However, even if the actual implementations in the described embodiments are different, ID token and the system of identification and identity verification still keeps the same advantages of quickly and reliably verifying an identity without needing to provide any confidential documents, therefore avoiding the risk of exposing private and sensitive data to untrusted parties.

### Additional Embodiments

Based on the disclosure and teachings provided herein, a person of ordinary skill in the art will appreciate other ways and/or methods to implement the various embodiments and that many modifications and variations are possible, for example, in some embodiments:
The type of the ID token (ID type) may or may not be publicly readable.
When creating a new ID token, the creator smart contractor the user 12 can select the value for the ID type from a set of predefined of values, or it can be calculated and decided upon based on the fields of information provided by the user. Such value can be decided precisely, following the definitions in the table in FIG. 7.
The ID type can be a 256-bit value or any N-bit value (with N can be any number, i.e., 128, 10, 50, 100 . . . ).
One ID token may have more than one type (ID type), and each type may be associated with one ID hash.
There may be more than one ID hash in ID token. For example, ID hash2 can be produced from some of the fields of information while ID hash is still the main one. Each hash value can be used in different contexts to increase the flexibility of ID token.
The creator smart contract of ID token can use a different method to form the ID hash from the raw input of user's identification information. For example, it can choose to hash each field of information, concatenate the result with the next field and hash the concatenated string again. It repeats the process until there is no field of information left.
The creator smart contract may check the existence of the identification hash (ID hash) before creating the ID token. It may choose not to create the ID token if the same ID hash already exists, to make sure there is not more than one ID token share the same ID hash on the blockchain.
The address of the registrar in the ID token may or may not be publicly readable. It may be accessed by the parties with authorized permissions only.
Registrar address in an ID token may be made mutable to provide flexibility. It may be changed and updated to a new registrar. A new registration may be needed with this new registrar.
The registrar address stored in the ID token may not point to a crypto wallet but instead to a smart contract that belongs to the registration authority or the registrar. This contract may provide extra functionalities.
The registration authority may not be the same authority who provided and certified the traditional papers. They can be other trusted parties who are qualified to confirm the evidence with accuracy and trusted by the public.
Metadata file of the ID token can store some other information, such as, for example, a link to an ID photo, whether it is encrypted or not encrypted, and/or the checksum of the photo, and/or some public information of a person's identity (such as name, nationality, etc.), and/or their public key, and/or their email address and so on.
Some non-private fields of information (for example, “COUNTRY”) can be made publicly readable in the ID token, for the same purpose of increasing flexibility.
The token address of the ID token may have a different length rather than 32 bytes.
The ID token address can take a different form rather than a hexadecimal string and can be computed by a different method, as long as it produces the same characteristics and is uniquely representative for the token on blockchain.
When providing information to create an ID token, the user can list all of the fields in one string where the fields are separated by commas or any other valid characters for separation, such as, for example, semicolons, colons, or other special characters such as hash (#), etc., the user can also provide fields of information as separated parameters.
When requesting that the creator smart contract creates the ID token, the user may specify the type of the ID token or not. If the user does not specify the type of the token, the creator can decide the type based on the fields of information provided by the user.
When forming the ID token, the creator can decide to normalize all the string values or not. I recommend normalizing them, for example by converting all the letters in lowercase or uppercase and remove the redundant spaces.
After forming the ID token, the creator can ask the user to provide information again to make sure the user has provided no mistakes; or the creator may not ask.
When storing a newly created ID token on a blockchain, the creator 20 can choose to store the ID token in another wallet rather than the wallet of the user.
Different format for the string of identification information details can be used.
The checksum of the encrypted photo can also be stored in the metadata file, for better security measure.
The checksum of the original photo can also be stored as a separate property in the ID token.
A different function can be used in place of MD5 to calculate the checksums of original and encrypted ID photos.
The photos can be encrypted and decrypted by another mechanism instead of private/public keys, such as a passphrase provided by the user.
The photos can also be encrypted/decrypted by a key which is the hash or a part of the identification hash (ID hash) which is calculated from the identification information.
The cryptographic hash functions used throughout the embodiments (including but not limited to the calculations of ID hash, hash1, computed hash, registry record) can be based on a different standard or algorithm. For example, it can be based on one of the algorithms, including, but not limited to: SHA-2 (i.e., SHA-224, SHA-256, SHA-384, SHA-512, SHA-512/224 and SHA-512/256) or SHA-3 (i.e., SHA3-224, SHA3-256, SHA3-384, SHA3-512, SHAKE128 and SHAKE256), or any variation and/or combination thereof.
Different hash algorithms may also be used for different calculations. For example, the calculation of ID hash can be based on SHA-3 and calculation of a registry record can be based on SHA-2.
In the registration process (FIG. 3A) either the user 12 or the creator smart contract can request that the registrar 18 registers the ID token.
In the registration process (FIG. 3B), the registrar 18 can ask the user 12 to provide evidence as described or it can use any other method to confirm their identity, such as manual confirming in person or automatically by computer with image processing, etc.
In the identification and verification processes, different values or texts rather than the ones proposed (i.e. “Verified”, “Not-Verified”, “Identified”, and “Unidentified”) can be used in responses.
The registrar or the registration authority may be able to modify a record that has been registered on blockchain.
The calculation of the registry record can be a different hash function or another computation method that provides the same characteristics as hash functions.
The registry record or digital certificate token may be made transferable and can be transferred to another wallet of the same registration authority or to another one.
The creator and the registrar can be the same smart contract.
The user can create an ID token without registering it or planning to register it later in time. All depends on the requirement from the application or the necessity of the situation.
The user can use any method to prove their ownership to the crypto wallet, either by signing in to it (with a method like Sign In With Ethereum) or any other way such as doing some transactions from the wallet.
The system and ID token can be deployed on a different blockchain rather than Ethereum, to increase the efficiency and compatibility and/or to reduce the gas fees.
The registry record can be formed directly from the wallet address and the identification hash, without using the token address.

### Conclusion

Through understanding the process described here, the reader will see that at least one embodiment of the identification token and its system provides a universal, convenient, and more reliable way to verify a real-life identity of an internet user. It also enhances privacy protection, reduces the risk of fraudulent activities and scams in online transactions.

Furthermore, embodiments can be used not only for verifying identities online but also for offline purposes. For examples, identification (ID) tokens can be used as an effective measure against identity theft and counterfeiting ID cards, to save costs, to facilitate mutual sharing between states and governments, and to reduce concerns about privacy issues.

By way of example, governments around the world keep trying to improve security features on their physical (ID) cards. In the United States, one of the requirements for a REAL ID is it must have security features designed to “prevent tampering, counterfeiting, or duplication of the driver's licenses and identification cards for fraudulent purposes”. However, one of the issues with these security features on physical cards is that, they are not (or will not be) strong enough and will soon be bypassed by criminals. Other new security features will be introduced but it takes a lot of time and costs a lot of money to replace the old ID cards with new ones; and they again will soon be obsolete.

Another problem comes with the traditional ID card systems is that their information needs to be stored in a system of centralized servers and databases which are also targets for hackers. Further, these centralized systems are managed by different government bodies, and it causes issues and privacy concerns when these authorities are required to share their databases with each other. For example, again in the United States, “The Real ID Act requires that states and territories share their ID databases with each other . . . ”; however, “many privacy rights advocates charged that by creating a national system electronically storing vast amounts of detailed personal data about individuals, the Real ID Act increased the chance of such data being stolen and thus raised the risk of identity theft”, which are valid concerns.

With ID tokens, there is no need for “states and territories” to “share their ID databases with each other” (however, each can still choose to keep and maintain their own current databases). The identification tokens and registry records are all on a blockchain. It will become very difficult, or almost impossible, for any hacker to attack the system to modify and fake the records. The system is protected by the proven security of the blockchain.

Further, the records on blockchain are publicly accessible by everyone, including government personnel from other states or territories. However, no “detailed personal data about individuals” is stored; no human-readable information can be seen. Each state and territory can certify their own citizens, stores the registry records on blockchain. All other states and territories can access and use these records to verify identity of any individual at any time, from anywhere, without the need of accessing to the person's confidential documents and the risks of exposing the data to unwanted actors.

Finally, those of skill in the art will recognize that embodiments may be practiced to support not only personal identities but also licenses and other real-life asset certifications, including, but not limited to, business licenses, skill certificates, certificates of ownership for houses, cars, etc. Any traditional government or non-government issued and/or certified papers can also be transformed to identification tokens and their registry records on the blockchain.

This transition, while adopting the advantages of the blockchain technology, such as decentralization, enhanced security, traceability and transparency, it still retains enough control in the hand of governments and authorities. On the one hand, it increases the efficiency in the traditional administrative procedures and processes. On the other hand, it gives the governments more time to adapt, helping the technology gradually gain more credibility and paves the way for it to be more applicable and accessible to the public.

While my above description contains many specificities, these should not be construed as limitations of the scope of this disclosure, but rather as an exemplification of several embodiments thereof.

Some portions of this description describe the embodiments of the present disclosure in terms of algorithms. These operations, while described functionally, computationally, or logically, are understood to be implemented by computer programs or equivalent electrical circuits, micro-code, or the like. The described operations may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the present disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to herein may include a single processor or may be implemented with architectures employing multiple processor designs for increased computing capability.

Embodiments of the present disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Embodiments can utilize at least one network that would be familiar to those skilled in the art for supporting communications using any of a variety of commercially available protocols, such as TCP/IP, FTP, UPnP, NFS, and CIFS. The network can be, for example, Local Area Network (LAN), Wide Area Network (WAN), a Virtual Private Network (VPN), the Internet, an intranet, an extranet, a peer-to-peer network, a public switched telephone network, an infrared network, a wireless network, or any combination thereof.

Embodiments of the present disclosure may also be practiced in distributed computing environments where tasks or modules are performed by remote processing devices, which are linked through a communications network, such as a LAN, WAN, or the Internet. In a distributed computing environment, program modules or subroutines may be located in both local and remote memory storage devices. Those skilled in the relevant art will recognize that portions of the described technology may reside on a server computer, while corresponding portions reside on a client computer (e.g., PC, mobile computer, tablet, or smart phone). Data structures and transmission of data particular to aspects of the technology are also encompassed within the scope of the described technology.

Embodiments of the present disclosure may utilize public or private blockchain infrastructures, distributed ledgers, append-only databases, and the like.

In embodiments utilizing a Web server, the Web server can run any of a variety of server or mid-tier applications, including, but not limited to, HTTP servers, FTP servers, CGI servers, JSON servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Perl, Python, or TCL, as well as combinations thereof. The server(s) may also include database servers, including without limitation those commercially available from Oracle®, Microsoft®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element, or keypad) and at least one output device (e.g., a display screen, a display device, printer, or speaker). Such a system may also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed, and/or removable storage devices as well as storage media for temporarily and/or more permanently containing, storing, transmitting, and retrieving computer-readable information. The system and various devices also can include a number of software applications, modules, services, or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets, APIs, scripts, and the like), or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD), or other optical storage, magnetic cassettes, magnetic tape, magnetic disk storage, or other magnetic storage devices, or any other medium which can be used to store the desired information and which can be accessed by a system device.

The foregoing description of the embodiments of the present disclosure has been presented for the purpose of illustration; it is not intended to be exhaustive or to limit the invention to the precise forms disclosed. The description and drawings are, accordingly, to be regarded in an illustrative rather than a restrictive sense. The language used in the specification has been principally selected for readability and instructional purposes. It is therefore intended that the scope of the invention be limited not by this detailed description and drawings, but rather by any claims that issue based on this application. It will, however, be evident that various modifications and changes may be made thereunto without departing from the broader spirit and scope of the invention as set forth in the claims.

1. A method for identification, comprising:
a. receiving identification information (IDI) from an individual;
b. generating a first unique identifier from said IDI;
c. getting a second unique identifier associated with a non-fungible token (NFT) wherein said NFT is held in a crypto wallet, wherein the individual has authorized access to said crypto wallet; and
d. applying at least one deterministic rule on both said first unique identifier and said second unique identifier, thereby deciding whether they are correlated;
whereby deciding whether said individual is identified based on the deterministic result of said rule applied on said unique identifiers.

2. The method of claim 1, wherein said deterministic rule is selected from the group consisting of an arithmetic rule, a logical rule, a rule involves a cryptographic algorithm, a string-manipulation rule, and a matching rule.

3. The method of claim 1, wherein said NFT is an identification (ID) token.

4. The method of claim 1, wherein the step of generating comprises:
a. arranging said IDI in at least one set of ordered-strings, according to at least one set of arranging rules, wherein said set of ordered-strings contains at least one ordered-string;
b. formatting each string in said set of strings, according to a set of formatting rules; and
c. applying a deterministic algorithm on each member of said set of ordered-strings in a specific order wherein said order defined by said set of arranging rules;
whereby a unique and deterministic value is computed from said IDI without being impacted by variations in the format or redundancy in said IDI.

5. The method of claim 4, wherein said set of arranging rules comprises:
a. at least one identification (ID) type number,
b. a table, mapping a set of fields of IDI to a series of numbers,
c. a filtering rule, filtering and keeping needed fields of IDI from said set of fields of IDI, based on the value of said ID type number, and
d. an ordering rule putting said needed fields of IDI in an order,
whereby all needed fields of IDI, and their order, are decided, based on said ID type number.

6. The method of claim 4, wherein said set of formatting rules comprises:
a. a rule to decide a delimiter,
b. a rule to decide a filler,
c. a rule to filter characters, and
d. a rule to convert characters,
whereby all strings in said set of ordered-strings are normalized and/or formalized.

7. The method of claim 4, wherein said deterministic algorithm comprises:
a. applying a cryptographic hash algorithm on the first string in said set of ordered-strings; thereby a first hash is generated;
b. concatenating the next string in said set of ordered-strings to said first hash; thereby an intermediary string is formed; and
c. repeating said applying step on said intermediary string and concatenating until there is no string left in said set of ordered-strings to concatenate, thereby the hash resulted from the applying step on the final intermediary string is a final hash;
whereby said final hash is unique, deterministic, and fixed-length.

8. A method for creating identification tokens, comprising:
a. receiving identification information (IDI) from an individual;
b. generating a first unique identifier from said identification information;
c. minting a non-fungible token (NFT) on a blockchain and associate said first unique identifier with said NFT; and
d. associating a second unique identifier with said NFT;
whereby said NFT is uniquely associated with said first identifier and said second unique identifier.

9. The method of claim 8, wherein said second unique identifier is selected from the group consisting of a crypto wallet address, a smart contract address, a unique identifier on a blockchain.

10. The method of claim 8, wherein said step of generating comprises:
a. arranging said identification information in at least one set of ordered-strings, according to at least one set of arranging rules, wherein said set of ordered-strings contains at least one ordered-string;
b. formatting each string in said set of ordered-strings, according to a set of formatting rules; and
c. applying a deterministic algorithm on each member of said set of ordered-strings in a specific order wherein said order defined by said arranging rules;
whereby a unique and deterministic value is computed from said IDI without being impacted by variations in the format or redundancy in said IDI.

11. The method of claim 10, wherein said set of arranging rules comprises:
a. at least one identification (ID) type number,
b. a table, mapping a set of fields of identification information (IDI) to a series of numbers,
c. a filtering rule, filtering and keeping needed fields of IDI from said set of fields of IDI, based on the value of said ID type number, and
d. an ordering rule putting said needed fields of IDI in an order,
whereby all needed fields of IDI, and their order, are decided, based on said ID type number.

12. The method of claim 10, wherein said set of formatting rules comprises:
a. a rule to decide a delimiter,
b. a rule to decide a filler,
c. a rule to filter characters, and
d. a rule to convert characters,
whereby all strings in said set of ordered-strings are normalized and/or formalized.

13. The method of claim 10, wherein said deterministic algorithm comprises:
a. applying a cryptographic hash algorithm on the first string in said set of ordered-strings; thereby a first hash is generated;
b. concatenating the next string in said set of ordered-strings to said first hash; thereby an intermediary string is formed; and
c. repeating said applying step on said intermediary string and concatenating until there is no string left in said set of ordered-strings to concatenate; thereby the hash resulted from the applying step on the final intermediary string is a final hash;
whereby said final hash is unique, deterministic, and fixed-length.

14. A method for producing a registry record, comprising:
a. getting a crypto wallet address wherein an individual has authorized access to said wallet;
b. getting a unique identifier associated with a first non-fungible token (NFT) wherein said first NFT is held in said crypto wallet; and
c. applying a deterministic computation on said wallet address and said unique identifier, thereby a registry hash is generated;
whereby said registry hash is unique and can only be reproduced when both said wallet address and said unique identifier are provided.

15. A method of claim 14, wherein said unique identifier is selected from the group consisting of a token address, an identification token address, a portion of an identification token address, an identification hash, a portion of an identification hash, and a unique identifier on a blockchain.

16. A method of claim 14, wherein said deterministic computation comprises:
a. applying a cryptographic hash algorithm on a value which is selected from the group consisting of said wallet address, and said unique identifier; thereby a hash is generated;
b. concatenating the remaining value in said group consisting of said wallet address, and said unique identifier, to said hash; thereby a concatenated string is generated; and
c. applying said cryptographic hash algorithm on said concatenated string; thereby the registry hash is generated.

17. A method of claim 14, further comprising:
a. minting a second non-fungible token (NFT) on a blockchain;
b. associating said registry hash to said second NFT; and
c. associating said second NFT with a registrar address.

18. A method of claim 14, further comprising:
a. searching for an existence of said registry hash on a blockchain.

19. A method of claim 18, wherein searching comprises:
a. getting a registrar address associated with said first NFT;
b. enumerating all registry records that are associated with said registrar address; thereby a list of existing records are generated; and
c. checking if said registry hash is associated with any record in said list of existing records.

20. A tangible, computer-readable medium in which is non-transitorily stored computer program code that, when executed by a computer processor, cause performance of a method for identity verification, the method comprising:
a. getting a crypto wallet address wherein an individual has authorized access to said wallet;
b. getting a token address associated with an ID token wherein said ID token is held in said crypto wallet;
c. applying a cryptographic hash algorithm on a value which is selected from the group consisting of said wallet address, and said token address; thereby a hash is generated;
d. concatenating the remaining value in said group consisting of said wallet address, and said token address, to said hash; thereby a concatenated string is generated;
e. applying said cryptographic hash algorithm on said concatenated string; thereby a registry hash is generated;
f. getting a registrar address associated with said ID token;
g. enumerating all registry records that are associated with said registrar address; thereby a list of existing records are generated; and
h. checking if said registry hash is associated with any record in said list of existing records;
whereby the identity verification status of said individual is determined, based on the result of said checking.
